(19) United States
(12) Patent Application Publication
(10) Pub. No.: US 2013/0278984 A1
(43) Pub. Date: Oct. 24, 2013

(54) OPTICAL SCANNING DEVICE

(71) Applicants: Takeshi Honda, Tokyo (JP); Nobuaki Takanashi, Tokyo (JP)

(72) Inventors: Takeshi Honda, Tokyo (JP); Nobuaki Takanashi, Tokyo (JP)

(21) Appl. No.: 13/996,493

(22) PCT Filed: Feb. 27, 2012
(86) PCT No.: PCT/JP2012/054762

§ 371 Date: Jun. 20, 2013

(30) Foreign Application Priority Data
Feb. 25, 2011 (JP) 2011-040223

(51) Int. Cl. G02B 26/10

(52) U.S. Cl. CPC G02B 26/10
USPC 359/199.1

(57) ABSTRACT

Optical scanning device 10 according to the present invention includes: plate-like movable mirror 11 having reflection surface 12 for reflecting light on one surface, and piezoelectric unit 13 including a plurality of piezoelectric elements on the other surface; a pair of torsionally deformable torsion beams 2 and 3 arranged opposite to each other at both ends of movable mirror 11 and swingably supporting movable mirror 11; driving units 4 and 5 for driving movable mirror 11 to oscillate; and compensating voltage application means 8 for applying a compensating voltage that is an alternating-current voltage to piezoelectric unit 13 when movable mirror 11 oscillates, thereby causing compensatory deformation in movable mirror 11 to compensate for deformation that occurs in movable mirror 11 due to the oscillation of movable mirror 11.

### TECHNICAL FIELD

The present invention relates to an optical scanning device.

### BACKGROUND ART

The optical scanning device that scans light by causing a mirror to oscillate is widely used in a digital copying machine, a laser printer, a barcode reader, a scanner, or a projector. With the recent development of a microfabrication technology, an optical scanning device that uses MicroElectro Mechanical Systems (MEMS) technology has become a focus of attention, as such an optical scanning device.

The optical scanning device based on MEMS technology has the following advantage. In such an optical scanning device, a mirror having both ends supported by torsion beams that are made of an elastic member oscillates about an oscillation axis along the torsion beams by a driving force such as an electrostatic force or an electromagnetic force, and accordingly optical scanning is carried out. Thus, unlike an optical scanning device of a type in which a polygon mirror or a galvano-mirror is rotated by a motor, a mechanical driving mechanism such as a motor is not necessary. As a result, the structure is simpler and assembling performance is higher, thereby contributing to lower costs. Furthermore, the oscillation angle of the mirror can be set relatively large as compared with the aforementioned optical scanning device that uses a motor. This is particularly important for displaying an image on a large screen by an image display device such as a projector.

In the optical scanning device based on MEMS technology, in many cases, to increase the oscillation angle of the mirror, a resonant mirror driven at the resonance frequency of a structure is used. Recently, high-speed oscillation of about several 10 kHz is required as a resonance frequency for displaying an image on large screen. The resonance frequency is known to be proportional to square root of a torsion spring constant of the torsion beam supporting the structure and to be inversely proportional to square root of the moment of inertia of the structure. Thus, the moment of inertia is preferably as small as possible for the configuration of a movable unit (mirror) to achieve the aforementioned high-speed motion.

In the case of a high-resolution projector where a sufficiently large mirror size is required, a plate-like mirror may be formed thin to keep the moment of inertia of the mirror small. However, the thin mirror reduces rigidity, and the mirror may be deformed (deflected) by high-speed oscillation. This dynamic deflection is a big problem because it causes image deterioration.

To solve the problem, there has been proposed a technology for reducing the dynamic deflection of the mirror by providing ribs on the rear surface of the mirror to improve rigidity (see, e.g., Non-Patent Literature 1 and Non-Patent Literature 2).

### CITATION LIST

### Non-Patent Literature

Non-Patent Literature 1: Chang-Hyeon, J., et al., Digest of Technical Papers. Transducers '05, US, pp. 992-995, 2005
Non-Patent Literature 2: Tang, T.-L., et al., Journal of Micromechanics and Microengineering, UK, Vol. 20, No. 2, 025020, 2010

### SUMMARY OF INVENTION

### Problems to be Solved

However, for example, in the case of causing the mirror having a mirror diameter (i.e., length in a direction orthogonal to an oscillation axis) of 1 mm or larger to oscillate at a frequency of 20 kHz or higher, ribs having a thickness of 100 to several 100 μm must be provided to sufficiently reduce the dynamic deflection of the mirror. The addition of such ribs consequently leads to the great increase of the moment of inertia of the mirror. Thus, even when the problem of image deterioration is reduced by providing the ribs to reduce the dynamic deflection, desired optical scanning performance such as a high-speed motion or a large oscillation angle of the mirror cannot be achieved due to the increase of the moment of inertia of the mirror.

It is therefore an object of the present invention to provide an optical scanning device capable of preventing the occurrence of dynamic deflection of a mirror while preventing reduction of optical scanning performance.

### Solution to Problem

To achieve the object, an optical scanning device according to the present invention includes: a plate-like movable mirror having a reflection surface for reflecting light on one surface, and a piezoelectric unit including a plurality of piezoelectric elements on the other surface; a pair of torsionally deformable torsion beams arranged opposite to each other at both ends of the movable mirror and swingably supporting the movable mirror; a driving unit for driving the movable mirror to oscillate; and compensating voltage application means for applying a compensating voltage that is an alternating-current voltage to the piezoelectric unit when the movable mirror oscillates, thereby causing compensatory deformation in the movable mirror to compensate for deformation that occurs in the movable mirror due to the oscillation of the movable mirror.

### Effects of Invention

As described above, according to the present invention, the optical scanning device capable of preventing the occurrence of dynamic deflection of the mirror while preventing reduction of optical scanning performance can be provided.

### BRIEF DESCRIPTION OF DRAWINGS

FIG. 1A is a schematic plan view showing an optical scanning device according to a first embodiment of the present invention as viewed from a light reflection surface side;

FIG. 1B is a schematic plan view showing the optical scanning device shown in FIG. 1A as viewed from a side opposite to the light reflection surface;

FIG. 1C is a schematic cross-sectional view taken along line A-A′ shown in FIG. 1B;

FIG. 2A is a schematic cross-sectional view for explaining the dynamic deflection of a movable mirror in the optical scanning device, corresponding to the static state of the movable mirror;

FIG. 2B is a schematic cross-sectional view for explaining the dynamic deflection of the movable mirror in the optical scanning device, corresponding to the oscillating state of the movable mirror;

FIG. 3 is a graph showing the time dependence of compensating voltages applied to first and second piezoelectric units of the optical scanning device shown in FIGS. 1A to 1C;

FIG. 4 is a view showing a configuration example of an image display device including the optical scanning device of the present invention;

FIG. 5A is a schematic plan view showing an optical scanning device according to a second embodiment of the present invention as viewed from a side opposite to a light reflection surface;

FIG. 5B is a schematic cross-sectional view taken along line B-B′ shown in FIG. 5A; and

FIG. 6 is a schematic plan view showing an optical scanning device according to a third embodiment of the present invention as viewed from a side opposite to a light reflection surface.

### DESCRIPTION OF EMBODIMENTS

Hereinafter, embodiments of the present invention will be described with reference to the drawings.

### First Embodiment

First, an optical scanning device according to a first embodiment of the present invention will be described. The optical scanning device of this embodiment is a resonant type optical scanning device configured to operate at a resonance frequency of a structure.

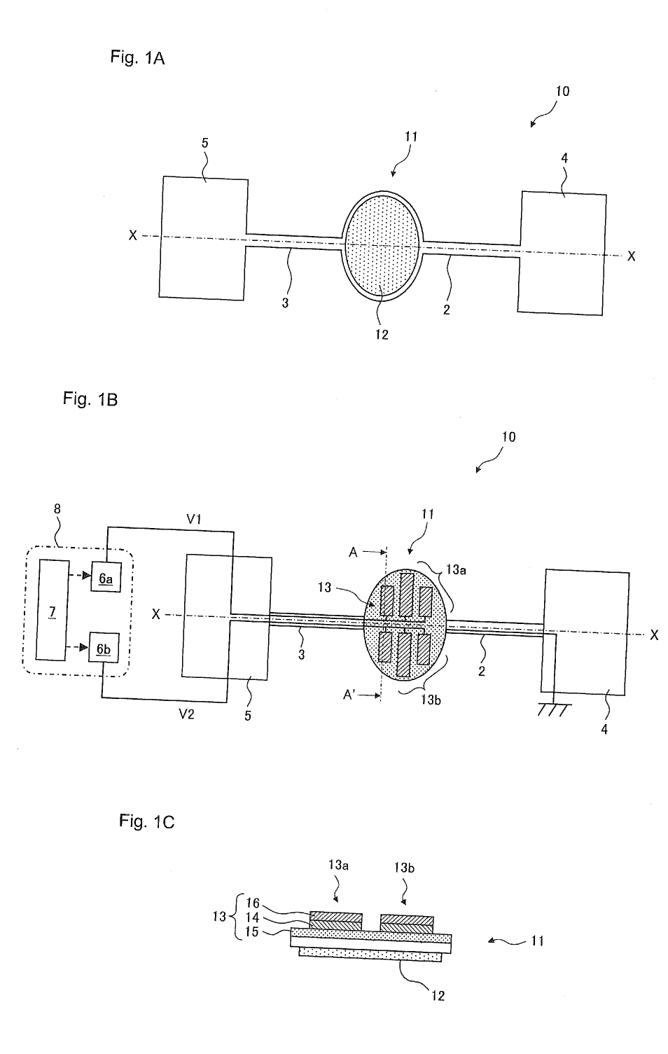

FIGS. 1A to 1C are schematic views showing the configuration of the optical scanning device of this embodiment. FIG. 1A is a schematic plan view showing the optical scanning device of this embodiment viewed from a light reflection surface side, and FIG. 1B is a schematic plan view showing the optical scanning device of this embodiment viewed from a side opposite to the light reflection surface. FIG. 1C is a schematic cross-sectional view taken along line A-A′ shown in FIG. 1B.

Optical scanning device 10 of this embodiment includes movable mirror 11 for scanning light, and a pair of torsionally deformable torsion beams 2 and 3 arranged opposite to each other at both ends of movable mirror 11 and connected to movable mirror 11. In other words, movable mirror 11 is swingably supported by torsion beams 2 and 3. Further, optical scanning device 10 includes driving units 4 and 5 that drives movable mirror 11 to oscillate. Accordingly, movable mirror 11 is driven by driving units 4 and 5 to oscillate about an oscillation axis along a direction in which rod-shaped torsion beams 2 and 3 extend.

Movable mirror 11 is formed into an elliptical plate shape so that its short-axis direction can be substantially coaxial to oscillation axis X-X of movable mirror 11. In other words, movable mirror 11 is formed to be substantially rotationally-symmetrical to oscillation axis X-X. This enables the moment of inertia of movable mirror 11 to be lower than that of a movable mirror rotationally asymmetrical to the oscillation axis. This is advantageous in that the torsion spring constant of torsion beams 2 and 3 for acquiring a predetermined resonance frequency (e.g., 20 kHz) can be reduced, thereby achieving a larger oscillation angle even with the same driving force.

Movable mirror 11 that is made of a moderately rigid and elastic material is formed integrally with torsion beams 2 and 3 and connected to driving units 4 and 5 via torsion beams 2 and 3. As material for movable mirror 11 and torsion beams 2 and 3, in this embodiment, elastic metallic material such as stainless or spring steel, or single-crystal silicon is preferably used.

Movable mirror 11 includes reflection surface 12 for reflecting light. In this embodiment, a mirror surface of a sufficiently flat metal thin film or dielectric multilayer that are made of a material having a sufficiently high reflectance for light to be used, is used as reflection surface 12. Such a mirror surface is formed on one surface (i.e., front surface) of movable mirror 11 by a method such as deposition.

Torsion beams 2 and 3 are, as described above, formed integrally with movable mirror 10, and swingably support movable mirror 11. The dimensions of torsion beams 2 and 3 are determined according to the moment of inertia calculated from the size of movable mirror 11 and the density of the material used for movable mirror 11. Specifically, a torsion spring constant for causing movable mirror 11 having the predetermined moment of inertia to oscillate at a predetermined resonance frequency is determined, and the dimensions of torsion beams 2 and 3 are accordingly determined.

Driving units 4 and 5 are configured to drive movable mirror 11 to oscillate by using a driving force such as an electrostatic force, an electromagnetic force, or a piezoelectric deformation force. The specific configuration of units 4 and 5 is not particularly restricted and can be appropriately selected according to the installation space or a necessary driving force. In this embodiment, driving units 4 and 5 also function as a support for supporting movable mirror 11 via torsion beams 2 and 3. However, a support can be provided separately from the driving units. To generate a large driving force to achieve a large oscillation angle of the mirror, a magnetic-force type driving device that generates a driving force with the aid of a permanent magnet and a coil is preferably used as the driving unit. In this case, either the permanent magnet or the coil can be disposed in the movable mirror while the remaining permanent magnet or coil can be disposed near the movable mirror, so that magnetic fields generated by the permanent magnet and the coil can be applied to each other.

When the plate-like movable mirror oscillates at a high speed, dynamic deflection occurs in the movable mirror as described above. To compensate for the dynamic deflection, in this embodiment, piezoelectric unit 13 that deforms movable mirror 11 when voltage is applied to it is provided on the other surface (i.e., rear surface) of movable mirror 11.

As shown in FIG. 1C, piezoelectric unit 13 includes lower electrode layer 15 and upper electrode layer 16 that are made of Al thin films or other materials such as Pt as electrode pads, and piezoelectric layer 14 sandwiched between electrode layers 15 and 16. Lower electrode layer 15 is formed on the entire rear surface of movable mirror 11, and piezoelectric layer 14 including a plurality of piezoelectric elements arranged at predetermined positions is formed thereon. Upper electrode layer 16 is stacked on piezoelectric layer 14.

In this embodiment, piezoelectric unit 13 is configured so that different alternating-current voltages can be applied to the regions of both sides that sandwich oscillation axis X-X. In other words, piezoelectric unit 13 includes two piezoelectric units 13a and 13b arranged opposite to each other to sandwich oscillation axis X-X of movable mirror 11. Accordingly, optical scanning device 10 includes two alternating-current voltage sources 6a and 6b for respectively applying alternating-current voltages to two piezoelectric units 13a and 13b.

First alternating-current voltage source 6a is connected to upper electrode layer 16 of first piezoelectric unit 13a via wiring, and adapted to apply first voltage V1 to first piezoelectric unit 13a. Second alternating-current voltage source 6b is connected to upper electrode layer 16 of second piezoelectric unit 13b via wiring, and adapted to apply second voltage V2 to second piezoelectric unit 13b. Lower electrode layer 15 is grounded. This configuration of this embodiment enables voltages V1 and V2 independent of each other to be applied to first and second piezoelectric units 13a and 13b. Thus, movable mirror 11 can be deformed to a desired shape by adjusting voltages V1 and V2 that are respectively applied to piezoelectric elements 13a and 13b.

Optical scanning device 10 of this embodiment includes control unit 7 that adjusts voltages V1 and V2 so that movable mirror 11 can be deformed to compensate for the dynamic deflection of movable mirror 11. Specifically, control unit 7 constitutes compensating voltage application means 8 together with two alternating-current voltage sources 6a and 6b, and is adapted to control first and second alternating-current voltage sources 6a and 6b to apply compensating voltages to first and second piezoelectric units 13a and 13b. The term “compensating voltage” as used herein means an alternating-current voltage for causing compensatory deformation (reverse deflection) in movable mirror 11 to compensate for or cancel the dynamic deflection of movable mirror 11.

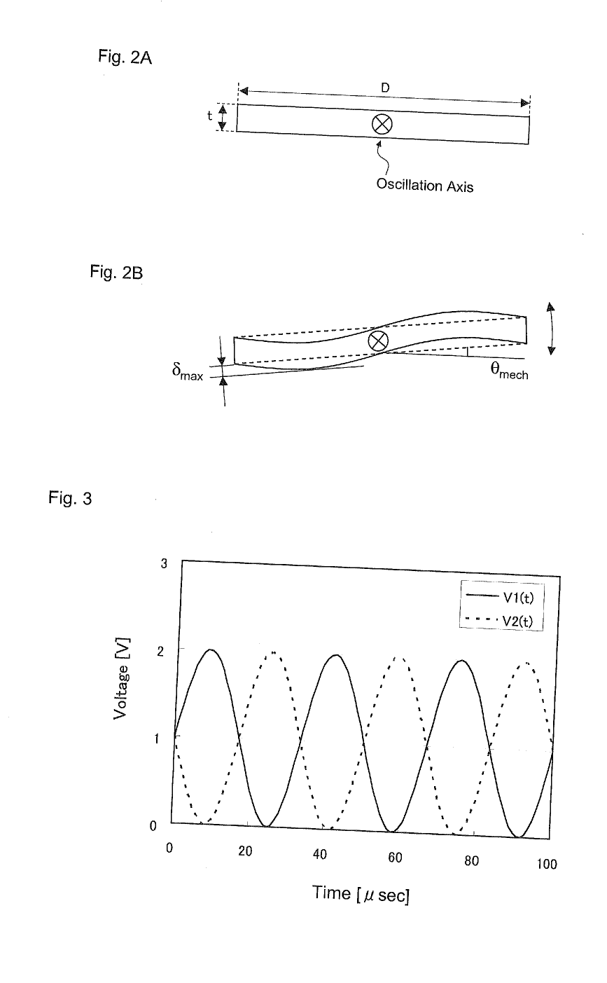

Now, the dynamic deflection and compensating voltage will be described by using the example of a movable mirror similar in configuration to that of this embodiment, i.e., a movable mirror rotationally-symmetrical to the oscillation axis. FIGS. 2A and 2B are schematic cross-sectional views showing the dynamic deflection of the movable mirror, and show cross sections vertical to the oscillation axis of the movable mirror. FIG. 2A corresponds to the static state of the movable mirror, and FIG. 2B corresponds to the oscillating (tilting) state of the movable mirror.

As shown in FIG. 2B, when the movable mirror is rotationally-symmetrical to the oscillation axis, possible dynamic deflection is rotationally-symmetrical to the oscillation axis. Specifically, a deflection may occur so that the regions of both sides of the movable mirror that sandwich the oscillation axis can be bent in vertically opposite directions. In this case, the maximum deflection amount (i.e., height from the plate surface when no deflection occurs to the vertex of the bent portion) δₘₐₓ of deflection that occurs on one side of the mirror is given by

δₘₐₓ≈0.217ρf²D⁵θ_{mech}/Et² (1)

where ρ is a material density, f is a resonance frequency, D is a mirror diameter (i.e., length in a direction orthogonal to the oscillation axis), θ_{mech} is a mirror oscillation angle from the static state, E is Young's modulus, and t is a mirror thickness.

As can be understood from Equation (1), the maximum deflection amount δₘₐₓ is proportional to the oscillation angle θ_{mech} of the movable mirror, and thus varies sinusoidally according to the oscillation of the movable mirror. This means that the dynamic deflection of the movable mirror occurs in synchronization with the oscillation cycle of the movable mirror. Since the dynamic deflection is rotationally-symmetrical to the oscillation axis, the oscillations of maximum deflection amounts on both sides that sandwich the oscillation axis have waveforms with inverted phases.

In this embodiment, first and second piezoelectric units 13a and 13b are arranged substantially linearly-symmetrical to oscillation axis X-X to correspond to movable mirror 11 formed substantially rotationally-symmetrical to oscillation axis X-X. Compensating voltage application means 8 is adapted to apply first and second voltages V1 and V2, which are synchronized with the oscillation cycle of movable mirror 11 and have inverted phases, as compensating voltages to piezoelectric units 13a and 13b. This can cause rotationally-symmetrical deformation, which changes according to the oscillation cycle of movable mirror 11, in movable mirror 11. As a result, by adjusting two compensating voltages V1 and V2 in phase and amplitude, reverse deflection in movable mirror 11 can be caused to cancel the dynamic deflection that occurs when movable mirror 11 oscillates. FIG. 3 shows an example of compensating voltages V1 and V2.

As in the case of this embodiment, each of the first and second piezoelectric units preferably includes a plurality of piezoelectric elements, each element extending in a direction orthogonal to the oscillation axis. Thus, each piezoelectric element can be deformed (distorted) in the extending direction, and the movable mirror can be bent in the direction orthogonal to the oscillation axis. This configuration is particularly advantageous when the mirror size is large.

As described above, in this embodiment, the piezoelectric unit including the plurality of piezoelectric elements is provided on the surface opposite to the reflection surface of the movable mirror. The compensating voltage is applied to the piezoelectric unit by the compensating voltage application means when the movable mirror oscillates. Thus, even when the movable mirror oscillates at a high speed, the planar state of the movable mirror can be substantially maintained by causing compensatory deformation in the movable mirror to compensate for the dynamic deflection of the movable mirror. As a result, the occurrence of dynamic deflection of the movable mirror that causes image deterioration can be prevented.

Furthermore, a thickness increased by adding the piezoelectric unit to the movable mirror is only about 3 to 10 μm. Accordingly, in this embodiment, as compared with the case of improving rigidity of the movable mirror by providing ribs therein, the occurrence of dynamic deflection can be prevented without increasing any volume overheads. In the case of the aforementioned method based on the addition of ribs, it is difficult to completely eliminate the dynamic deflection of the movable mirror because the rib itself is deflected. However, according to this embodiment, the elimination is facilitated by spontaneously deforming the mirror to cancel the dynamic deflection.

The number, the arrangement, and the shapes of the piezoelectric elements constituting the piezoelectric unit are not limited to those of the embodiment described above. They can be appropriately changed according to the size, shape, or operation speed of the movable mirror, i.e., according to the dynamic deflection that could actually occur. In this embodiment, the compensating voltage application means includes the alternating-current voltage source and the control unit that are separately provided. However, both can be integrally configured.

Now, the configuration and the operation of an image display device that includes the optical scanning device of this embodiment will be described.

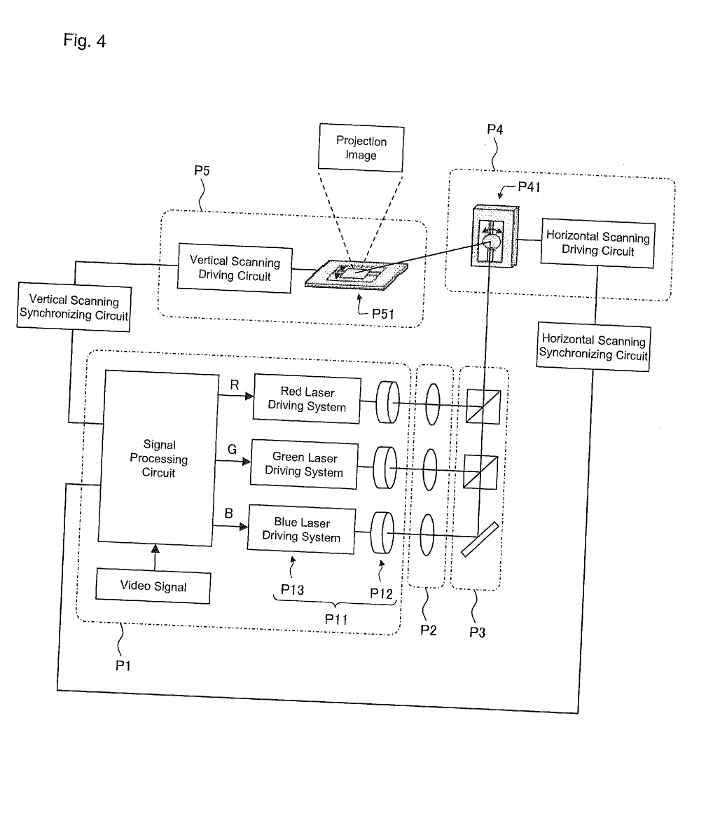

FIG. 4 shows a configuration example of the image display device that includes the optical scanning device of this embodiment.

The image display device includes light flux generation device P1 for generating a light flux of each color modulated according to a video signal supplied from the outside, collimator optical system P2 for converting each light flux generated by light flux generation device P1 into collimated light beam, and beam combiner P3 for synthesizing the light fluxes converted into collimated light beam. Furthermore, the image display device includes horizontal scanning unit P4 for scanning the light beam synthesized by beam combiner P3 in a horizontal direction to display an image, vertical scanning unit P5 for scanning the light beam scanned in the horizontal direction by horizontal scanning unit P4 in a vertical direction, and an optical system (not shown) for emitting the light beams scanned in the horizontal and vertical directions onto a screen. The optical scanning device of this embodiment is incorporated into the image display device as scanning mirror P41 of horizontal scanning unit P4.

Light flux generation device P1 includes a signal processing circuit that receives a video signal, generates a signal as an element for constituting an image based on the input signal, and outputs a horizontal synchronous signal used by the horizontal scanning unit and a vertical synchronous signal used by the vertical scanning unit. In this signal processing circuit, video signals of red (R), green (G), and blue (B) are generated.

Light flux generation device P1 further includes light source unit P11 for converting the three video signals (R, G, and B) output from the signal processing circuit into light fluxes. Light source unit P11 includes laser P12 for generating a light flux of each color of the video signal, and laser driving system P13 for driving laser P12. For each laser, a semiconductor laser or a solid laser having a second harmonic generation (SHG) mechanism is preferably used.

The light flux of each color output from each laser P12 of light flux generation device P1 is converted into collimated light beam by collimator optical system P2, and then entered into a dichroic mirror of beam combiner P3 that corresponds to each color. The light fluxes of the respective colors made incident on the three dichroic mirrors are wavelength-selectively reflected or transmitted to be synthesized, and output to horizontal scanning unit P4.

At horizontal scanning unit P4 and vertical scanning unit P5, the light beam incident on horizontal operation unit P4 is projected as an image by scanning mirrors P41 and P51 in the horizontal and vertical directions. Scanning mirrors P41 and P51 are driven by a scanning driving circuit based on the synchronous signals output from the signal processing circuit and input through the scanning synchronizing circuit.

### Second Embodiment

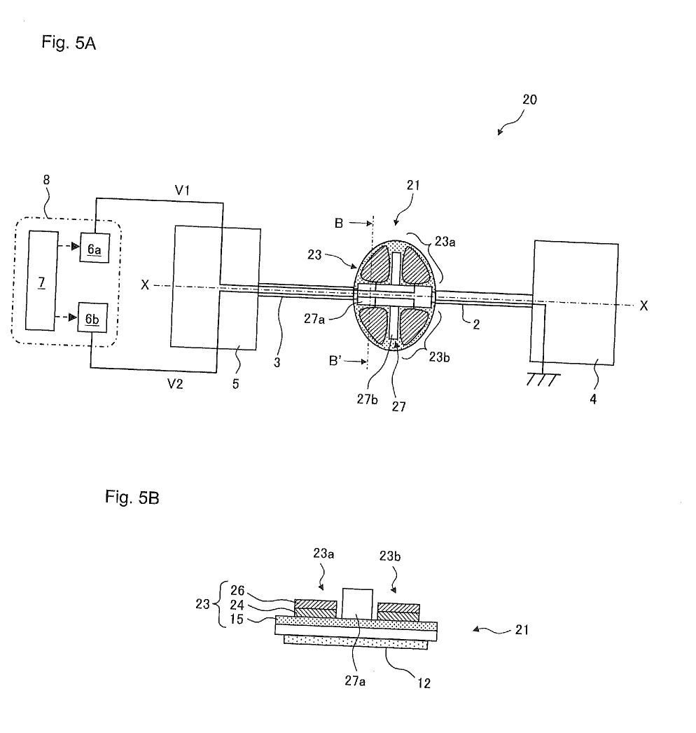

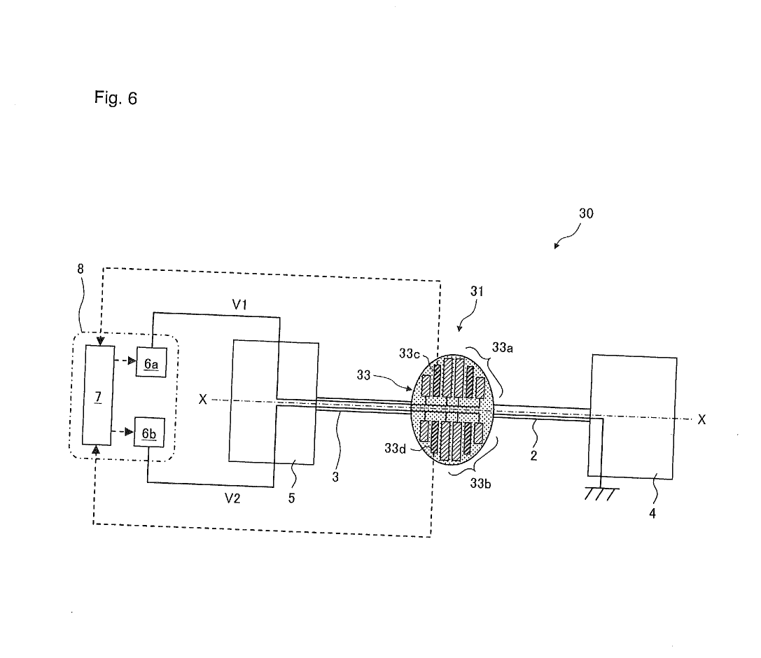

FIGS. 5A and 5B are schematic views showing the configuration of an optical scanning device according to a second embodiment of the present invention. FIG. 5A is a schematic plan view showing the optical scanning device of this embodiment viewed from a side opposite to a light reflection surface, corresponding to FIG. 1B. FIG. 5B is a schematic cross-sectional view taken along line B-B′ shown in FIG. 5A. As described below, this embodiment is a modification of the first embodiment where the configuration of the rear surface of the movable mirror is changed. In other words, when viewed from the reflection surface side, the configuration of the optical scanning device of this embodiment is similar to that of the first embodiment. Thus, no drawing corresponding to FIG. 1A is shown. Hereinafter, members similar to those of the first embodiment will be denoted by similar reference numerals shown, description thereof will be omitted, and only components different from those of the first embodiment will be described.

In optical scanning device 20 of this embodiment, movable mirror 21 includes rib 27 formed on a surface opposite to reflection surface 12. Rib 27 includes short-axial rib 27a extending along oscillation axis X-X of movable mirror 21, and long-axial rib 27b extending in a direction substantially orthogonal to oscillation axis X-X. Piezoelectric unit 23 is disposed in a region of the rear surface of movable mirror 21 where no rib 27 is formed. As in the case of the first embodiment, piezoelectric unit 23 includes first and second piezoelectric units 23a and 23b arranged substantially linearly-symmetrical to oscillation axis X-X of movable mirror 21.

According to this embodiment, since at least long-axial rib 27b is provided in the rear surface of movable mirror 21, the deformation amount of movable mirror 21 necessary for compensating for dynamic deflection can be reduced. Accordingly, the installation area of piezoelectric unit 23 can be reduced, and thus compensating voltage that is applied to piezoelectric unit 23 can be lowered. This can reduce power consumption necessary for preventing the occurrence of dynamic deflection of movable mirror 21. Furthermore, in this embodiment, rib 27 is formed near the center of the rear surface of movable mirror 21, and piezoelectric unit 23 is accordingly disposed in the peripheral region of movable mirror 21. This is also advantageous for reducing power consumption. This is because the installation area of piezoelectric unit 23 can be further reduced by providing rib 27 near the center of the mirror having large dynamic deflection.

It should be noted that the addition of a rib to this embodiment is a supplementary measure and, by itself, is not intended to greatly reduce the amount of deflection. The rib configuration is not limited to the aforementioned configuration. It can be appropriately changed within a range where the increase of the moment of inertia does not affect optical scanning performance.

### Third Embodiment

FIG. 6 is a schematic plan view showing the configuration of an optical scanning device according to a third embodiment of the present invention viewed from a side opposite to a light reflection surface. As described below, this embodiment is a modification of the first embodiment where different functions are added to the piezoelectric unit and the compensating voltage application means. In other words, in this embodiment, while the configuration is partially changed because of the addition of such functions, the basic structure is similar to that of the first embodiment except for the number of piezoelectric elements. Thus, FIG. 6 shows only a view from the side opposite to the reflection surface, corresponding to FIG. 1A. Hereinafter, members similar to those of the first embodiment will be denoted by similar reference numerals shown, description thereof will be omitted, and only components different from those of the first embodiment will be described.

In optical scanning device 30 of this embodiment, first and second piezoelectric units 33a and 33b are provided with piezoelectric sensors 33c and 33d, respectively. Piezoelectric sensors 33c and 33d are parts of the pluralities of piezoelectric elements constituting piezoelectric units 33a and 33b, and play the role of detecting deformation (deflection) that occurs in movable mirror 31. Specifically, in this embodiment, compensating voltage application means 8 is adapted to detect voltages generated in piezoelectric sensors 33c and 33d when movable mirror 31 oscillates and to apply compensating voltages V1 and V2 to the remaining piezoelectric elements of first and second piezoelectric units 33a and 33b so that the detected voltages can be zero. As a result, the case where a deflection amount generated in movable mirror 31 changes due to an external factor, such as a temperature or humidity, or with time, can be dealt with, and a variance on mirror deflection amount among the individual members can be dealt with.

In this embodiment, a rib similar to that of the second embodiment can also be provided as a supplementary measure.

While the present invention has been described with reference to the embodiments, the present invention is not limited to the embodiments described above. It will be understood by those skilled in the art that various changes in form and details may be made therein without departing from the scope of the present invention as defined by the claims.

The present application is based upon and claims the benefit of priority from Japanese Patent Application No. 2011-040223 filed on Feb. 25, 2011, the disclosure of which is incorporated herein in its entirety by reference.

### EXPLANATION OF REFERENCE NUMERALS

10, 20, 30 Optical scanning device
2, 3 Main torsion beam
4, 5 Driving unit
6a First alternating-current voltage source
7 Control unit
8 Compensating voltage application means
11, 21, 31 Movable mirror
12 Reflection surface
13, 23, 33 Piezoelectric unit
13a, 23a, 33a First piezoelectric unit
13b, 23b, 33b Second piezoelectric unit
14, 24 Piezoelectric layer
15 Upper electrode layer
16, 26 Lower electrode layer
27 Rib
27a Short-axial rib
27b Long-axial rib
33c, 33d Piezoelectric sensor

1. An optical scanning device comprising:
a plate-like movable mirror having a reflection surface for reflecting light on one surface, and a piezoelectric unit including a plurality of piezoelectric elements on the other surface;
a pair of torsionally deformable torsion beams arranged opposite to each other at both ends of the movable mirror and swingably supporting the movable mirror;
a driving unit that drives the movable mirror to oscillate; and
compensating voltage application means for applying a compensating voltage that is an alternating-current voltage to the piezoelectric unit when the movable mirror oscillates, thereby causing compensatory deformation in the movable mirror to compensate for deformation that occurs in the movable mirror due to the oscillation of the movable mirror.

2. The optical scanning device according to claim 1, wherein the compensating voltage application means is adapted to apply the compensating voltage to the piezoelectric unit in synchronization with an oscillation cycle of the movable mirror.

3. The optical scanning device according to claim 1, wherein:
the piezoelectric unit includes first and second piezoelectric units arranged opposite to each other with respect to an oscillation axis of the movable mirror; and
the compensating voltage application means is adapted to apply the compensating voltages of different signs to the first and second piezoelectric units.

4. The optical scanning device according to claim 3, wherein:
the movable mirror is formed to be substantially rotationally-symmetrical to the oscillation axis of the movable mirror, and the first and second piezoelectric units are arranged substantially linearly-symmetrical to the oscillation axis of the movable mirror; and
the compensating voltage application means is adapted to apply the compensating voltages having inverted phases to the first and second piezoelectric units.

5. The optical scanning device according to claim 3, wherein each of the first and second piezoelectric units includes a plurality of piezoelectric elements.

6. The optical scanning device according to claim 5, wherein each piezoelectric element extends in a direction substantially orthogonal to the oscillation axis of the movable mirror.

7. The optical scanning device according to claim 1, wherein the compensating voltage application means is adapted to detect the deformation by using some of the plurality of piezoelectric members and to apply the compensating voltage to the remainder of the plurality of piezoelectric members based on the detected deformation.

8. The optical scanning device according to claim 7, wherein the compensating voltage application means is adapted to apply the compensating voltage to the remainder of the plurality of piezoelectric members so that voltages generated in said some of the plurality of piezoelectric members can be zero.

9. The optical scanning device according to claim 1, wherein the movable mirror further includes a rib formed in said other surface of the movable mirror, and the piezoelectric unit is disposed in a region of said other surface of the movable mirror where no rib is formed.

10. The optical scanning device according to claim 9, wherein the rib extends at least in a direction substantially orthogonal to the oscillation axis of the movable mirror.

11. The optical scanning device according to claim 9, wherein the rib is formed near a center of the other surface of the movable mirror so that the piezoelectric unit can be disposed in a peripheral region of the movable mirror.
